(19) United States
(12) Patent Application Publication
(10) Pub. No.: US 2025/0005318 A1
(43) Pub. Date: Jan. 2, 2025

(54) SYSTEM AND METHOD FOR AUTOMATED DATA-DRIVEN DOMAIN MODEL SYNTHESIS

(71) Applicant: Filuta AI Inc., Houston, TX (US)

(72) Inventors: Filip Dvorak, Houston, TX (US); Tomas Balyo, Karlsruhe (DE); Martin Dousek, Praha 3 (CZ); Michal Ficek, Prague (CZ); Slavomir Svancar, Praha 9 (CZ); Josef Ryzí, Baška (CZ); Roman Barták, Plzen (CZ); Michal Halenka, Staré Mesto (CZ); Gregory Michael Youngblood, Las Cruces, NM (US); Lukas Chrpa, Praha 8 (CZ); Martin Suda, Praha (CZ); Stephan Gocht, Meissen (DE)

(21) Appl. No.: 18/761,015

(22) Filed: Jul. 1, 2024

Related U.S. Application Data
(60) Provisional application No. 63/524,594, filed on Jun. 30, 2023.

(51) Int. Cl. G06N 3/006; G06N 3/045; G06N 3/08

(52) U.S. Cl. CPC G06N 3/006; G06N 3/045; G06N 3/08

(57) ABSTRACT

A method for automated data-driven domain model synthesis is provided. Logs of data are received from a target system for which at least one goal is to be achieved. A set of predicates that describe a domain of the target system is determined from the logs. The set of predicates represents an initial state and sequence state changes. Each predicate applies to one or more objects in the domain. Domain synthesis is performed to create a model that describes the log data by adding the predicates and actions needed to achieve the goal. The model is revised by adding one or more missing predicates or actions when the model fails to cover all the logs.

### FIELD

This application relates in general to building models, and in particular to a system and method for automated data-driven domain model synthesis.

### BACKGROUND

Model synthesis involves developing multiple model designs and learning techniques. For example, applying various filters and transformations to a dataset ingested from a data connector can define a state space, which is used to learn a model for a system. When building a domain model, it is necessary to process offline data. Offline data sets, which are typically used for model learning, can be quite large and are not significantly constrained by processing time and results in longer processing times.

While the connectors are critical components of the system, the implementation effort has already been invested in several open-source data connectors, such as Airbyte (2023). Therefore, a need remains for a data-driven approach that takes operational logs from a system and creates a planning domain model in a modeling language. Preferably, names of actions are made human-friendly by using a Large Language Model to improve readability of the generated domain model.

### SUMMARY

The automated data-driven domain synthesis (“auto synthesis”) process aids a user in designing a model, such as in the planning domain definition language (PDDL), to describe the processes that are captured in the form of operational logs from a system. The auto synthesis may not deliver completely accurate models in some cases due to some theoretical limits of the underlying computational problem and the properties of the input logs. However, in general, results of the auto synthesis are better if the provided logs are diverse, including containing many different events that are possible in the process.

Also, to improve results, the auto synthesis process can be an interactive process. For example, a user can manually validate and adjust the model, if necessary. The auto synthesis system can then provide feedback on the user's adjustments, including whether all the events observed in the logs are covered by the action model and whether the action models include redundant or unused action that never occurred in the logs.

The auto synthesis system also supports incremental usage. This is useful when the processes get updated and new logs that include new types of events become available. In conjunction with the previous logs and the previous model, a new model can be synthesized more efficiently and will be more accurate.

An embodiment provides a method for automated data-driven domain model synthesis. Logs of data are received from a target system for which at least one goal is to be achieved. A set of predicates that describe a domain of the target system is determined from the received logs. The set of predicates represents an initial state and sequence state changes, while each predicate applies to one or more objects in the domain. Actions that are low-level execution steps to be performed for achieving the goal are transformed to actions that are high-level plan steps regarding achieving the goal. Actions that are high level plan steps regarding achieving the goal are identified and transformed to actions that are low level execution steps to be performed for achieving the goal. Domain synthesis is performed to create a model that describes the log data by adding the predicates and actions needed to cover all the logs and achieve at least one goal. A determination is made as to whether the model covers all the logs and the model is revised by adding one or more missing predicates or actions when the model fails to cover all the logs.

A further embodiment covers the semi-automatic generation of solvable test cases for evaluating the performance of automated planners in PDDL domains, with the ability to adjust the difficulty level of the problems to test scalability. The semi-automatic generation guarantees the generation of solvable instances, providing a reliable means to assess planner efficiency across various complexity levels.

Still other embodiments will become readily apparent to those skilled in the art from the following detailed description, wherein are described embodiments by way of illustrating the best mode contemplated. As will be realized, other and different embodiments are possible and the embodiments' several details are capable of modifications in various obvious respects, including time and clustering of events, all without departing from their spirit and the scope. Accordingly, the drawings and detailed description are to be regarded as illustrative in nature and not as restrictive.

### BRIEF DESCRIPTION OF THE DRAWINGS

FIG. 1 is a flow diagram showing a method for automated data-driven domain synthesis, in accordance with one embodiment.

FIG. 2 is a block diagram showing a system for automated data-driven domain synthesis, in accordance with one embodiment.

FIG. 3 is a flow diagram showing, by way of example, a process for generating the domain model of FIG. 1.

FIG. 4 is a block diagram showing, by way of example, architecture of a target system.

FIG. 5 is a flow diagram showing, by way of example, a process for processing raw logs via the data management module.

FIG. 6 is a flow diagram showing, by way of example, a process for pushing actions to be executed by the target system.

FIG. 7 is a flow diagram showing, by way of example, a process of the diff stage for generating actions.

FIG. 8 is a flow diagram showing, by way of example, a process for performing the merge stage.

FIG. 9 is a flow diagram showing, by way of example, a process for performing the refine stage.

FIG. 10 is a flow diagram showing, by way of example, a process for performing match or spawn.

FIG. 11 is a flow diagram showing, by way of example, a process for converting logs prior to processing.

FIG. 12 is screenshot of the user interface of the system for automated data-driven domain synthesis of FIG. 2.

FIG. 13 is a screenshot showing, by way of example, a log loaded via a user interface.

FIG. 14 is a screenshot showing, by way of example, a domain draft loaded via the user interface.

FIG. 15 is a screenshot showing, by way of example, options for controlling and displaying synthesis metadata via the user interface.

FIG. 16 is a screenshot showing, by way of example, a synthesized domain.

FIG. 17 is a screenshot showing, by way of example, additional synthesis options provided by the user interface.

FIG. 18 is a screenshot showing, by way of example, options for the synthesized domain displayed via the user interface.

FIG. 19 is a flow diagram showing, by way of example, a process for debugging models that overapproximate a problem.

FIG. 20 is a flow diagram showing, by way of example, a process for evaluating models.

### DETAILED DESCRIPTION

Generally, domain models are built by processing offline data. However, the offline data can exist in large amounts and are not significantly constrained by processing time, which can make building of domain models time consuming. A process that provides capabilities to learn individual models from provided datasets in sequential or time-ordered sequences can increase the efficiency of model building, as well as accuracy. The models can be built and maintained automatically with little to no human feedback. The models represent events and actions that can be used to plan in the operational space, solve domain problems, and automate systems on which the datasets were captured.

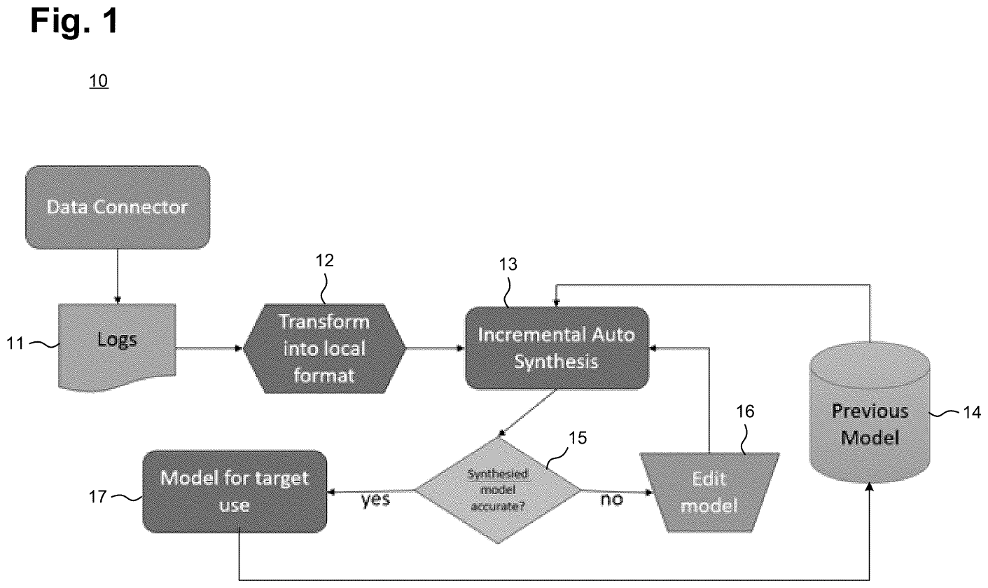

FIG. 1 is a flow diagram showing a method 10 for automated data-driven domain synthesis, in accordance with one embodiment. Operational logs from an external target system, such as via a data connector, is input (step 11). The logs can be interpreted and transformed (step 12) into a sequence of world states that are defined by true predicates. Incremental auto synthesis (step 13) is performed to generate a domain model, such as in PDDL format, that describes the log data. The auto synthesis can use an empty model or an existing model. When an existing model is used (step 14), attempts are made to interpret the logs with the given model. However, if not possible, the existing model can be extended by adding new types of objects that can appear in the logs, predicates, and actions.

A user examines the model to determine (step 15) whether the model accurately describes the processes provided in the logs. If the model is not accurate, the user can modify (step 16) the model using an editor tool, such as a visual editor, including Blockly, or by editing the source file, such as PDDL, as text. Auto synthesis is then performed on the modified model to verify that the modified model covers all the changes that appear in the logs.

However, if the model is accurate, the user can utilize (step 17) the model. For example, the model can be combined with a solver or a set of solvers that solve problems using the model. The model can also be used for documentation of processes or for reasoning about certain properties, model like complexity, and computability. The solver is a software tool or algorithm designed to solve specific problems and can be used in the context of constraint satisfaction problems, optimization problems, or logical reasoning tasks. Specifically, each solver can take a defined problem as input and applies various techniques and algorithms to search for a valid solution or to determine if a solution exists. The techniques and algorithms applied can be dependent on a nature of the problem being solved. For example, in constraint satisfaction problems, a solver can utilize backtracking, constraint propagation, or local search techniques to find a solution that satisfies a set of given constraints. However, in optimization problems, a solver can find a solution by evaluating and comparing different potential solutions based on an objective function.

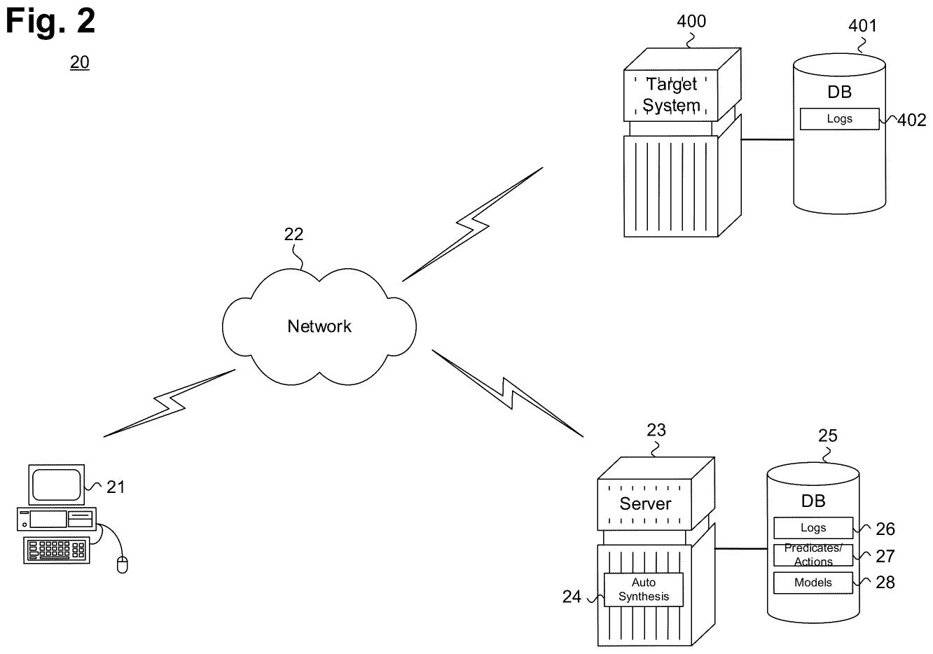

FIG. 2 is a block diagram showing a system for automated data-driven domain synthesis, in accordance with one embodiment. A user, in front of a computing device 21, such as a desktop, laptop, tablet, or cellular telephone, can identify a goal to be achieved or a problem to be solved for or within a target system, and provide the target system to be described by a model via an Internetwork 22. In one embodiment, logs for synthesis and a goal or initial state of the target system can be provided in a request for the user. The request can be received by a server 23, which includes a module for performing auto synthesis 24 to generate a model to achieve the goal requested by the user. To generate the model 28, the server 23 accesses log data 402 stored in a database 401 associated with a server 400 for the target system or provided by the user. The logs 402 can include an initial state and state changes of the system.

Once received, the logs 26, 402 are stored in the database 25. From the logs, predicates and actions 27 are identified and used in the model 28. The model is then fed to the target system for achieving the goal of the user. For example, the server 23, via a planner module (not shown), can generate a plan for solving the problem or achieving the goal, based on the model, initial state of the target system, and goal. In one embodiment, the model can be displayed to the user via the computing device 21 and revised based on any feedback of the user.

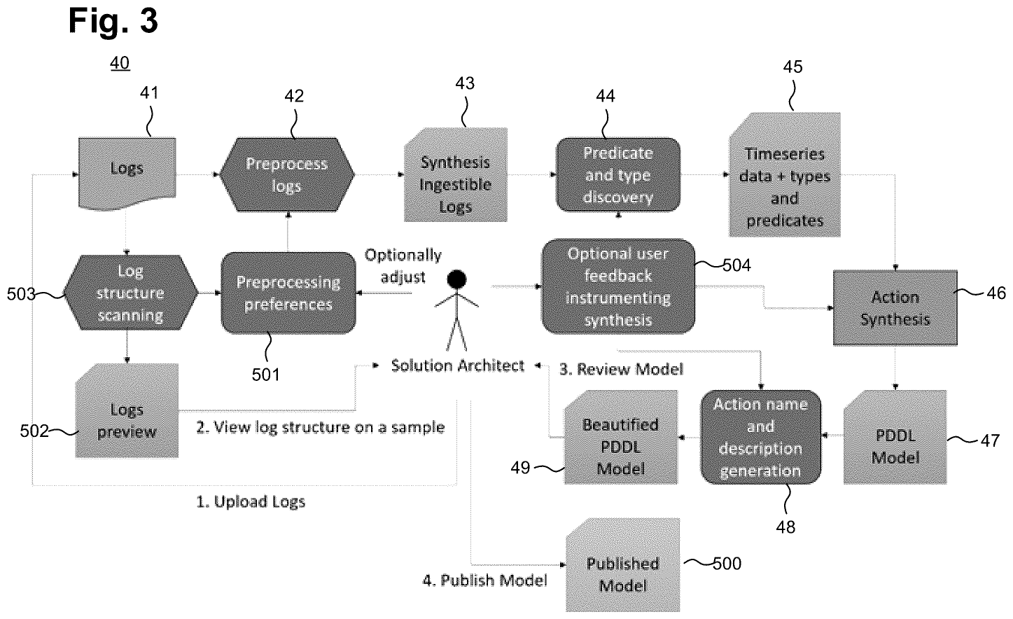

Specifically, auto synthesis can utilize user feedback or alternatively, generate the model without any feedback. FIG. 3 is a flow diagram showing, by way of example, a process 40 for generating the domain model of FIG. 1. Domain synthesis data derives causal symbolic models from timestamped state change records or logs of a system, which are input 41 for processing during domain synthesis. Optionally, the logs can be preprocessed 42 to only include variable changes relevant to the model to be synthesized or to include only certain log events. Based on the logs 43, predicates and types, which are described in detail below, are discovered 44 and used with other log data, such as timestamp data 45 to determine actions 46. The actions can be used to generate the model using a PDDL model 47. Action names and descriptions can be determined and added to the model 48 (resulting in a beautified PDDL Model 49), which can be reviewed by the user, and if approved, published 500. A solution architect, such as the user, can also review 504 and provide feedback during preprocessing by adjusting preprocessing preferences 501, rescanning the logs 503 and reviewing the logs 502. Furthermore, the solution architect may provide feedback during action synthesis, in addition to the model, based on a preview of updated logs. Specifically, the solution architect can provide required input or adjust names and types of variables 504 discovered during scanning of the logs.

Once preprocessed, the logs are submitted 43 to a multi-stage iterative synthesis process during which patterns in the system state changes are discovered and a model is generated. To aid the user in understanding the generated model, Large Language Models (LLMs) can be utilized to produce textual descriptions and meaningful names for actions 48. The domain model is presented to the user and the user can provide feedback, such as refusing a generation action to steer the synthesis of the model towards a different action atomicity level other than the minimized model with complex actions preferred by the synthesis. The user can also choose to augment the model with additional actions or adjust preconditions and effects beyond what was represented in the source time series data. Feedback from the user prompts a new synthesis iteration. Once the user accepts the model, the model is ready for use in the target system from which the logs were obtained.

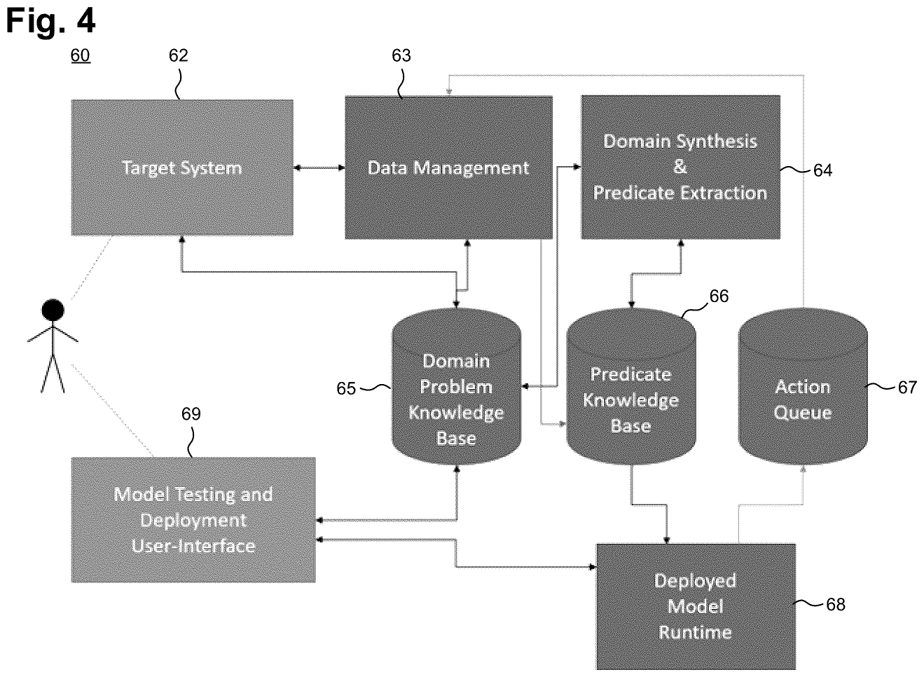

The target system 62 accepts actions and provides a perception of the system and its world's state. FIG. 4 is a block diagram showing, by way of example, architecture 60 of a target system. The user works with a back end system via a user interface 69 to define one or more domain models and a system of components that utilize the model running through tests and deployment to solve problems through action-space control. The backend system includes systems for data management 63, domain synthesis and predicate extraction 64, and deployed model runtime 68, as well as a domain problem knowledge base 65, predicate knowledge base 66, and action queue 67.

In one example, the target system can include a system for solving the Towers of Hanoi game, which is a puzzle that involves moving discs from one place to another. For instance, the game includes n rods, where n is typically 3, and a stack of different-sized discs. The goal of the game is to move all the discs from one rod to another, following a few rules. The rules include moving only one disc at a time, never putting a bigger disc on top of a smaller disc, and using the other rods to help move the discs around, but only placing a disc on top of another disc or on an empty rod.

The domain problem knowledge base 65 captures real world knowledge the model is designed to represent and consists of definitions of the target system's predicates and goals. A predicate is a function of a set of parameters that returns a Boolean as an answer by taking raw logs from a system, an expert's domain knowledge, existing domain knowledge, such as existing PDDL descriptions, and other sources that provide domain knowledge. The knowledge capture primarily involves preparing a set of predicates that describe the domain under interest following any method of knowledge capture from a consultant or domain expert. The knowledge base can include a description of predicates and their meaning, which are extracted from the target system's raw logs. The predicates apply to a specific type of object or to all objects.

The predicates are either true or false at any point and when not declared, they are assumed to be false. Returning to the game example, the knowledge base may contain information, such as the definition of useful predicates: “on(disc1, disc2) means disc1 is on disc2, smaller(disc1, disc2) means disc1 is smaller than disc2, clear(disc1) means disc1 is on the top and nothing lies on it. The goal to be achieved can also be defined, with the predicates. For example, the goal of the game is that “all discs lie on the last rod, with the predicates that are all true, such as disc_on_rod(disc1, rod3), disc_on_rod(disc2, rod3), and disc_on_rod(disc3, rod 3). Additionally, the initial state of the problem can be defined using predicates that describe all predicates describing the input scenario and all combinations of disc and their sizes and location.

Information from the target system 62 flows into and out of the data management module 63, which takes perception data from the external world state of the target system or other systems that accurately report data form the environment of the target system. The perception data can include any external information relevant to the domain of interest, such as weather, traffic conditions, or general knowledge from the outside world. The target system can provide telemetry or operational logs, such as a raw stream or batch of data collected from components of the system. Returning to the game example, the data can include keys pressed in the game by a human player.

The data management module also transmits action information to the target system, such as transformed planned actions that lead to actual system change. For example, in the Towers of Hanoi game, the planned action can include “move_disc_from_rod_to_rod,” which translated to the target system can mean “press arrow up, press arrow left, press arrow left, press arrow down” as a sequence of virtual keyboard key presses.

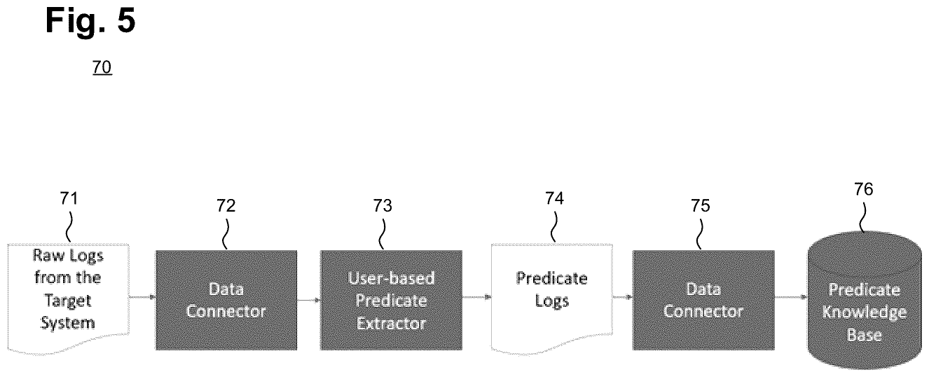

Internal to the data management module, multiple process flows can exist. FIG. 5 is a flow diagram showing, by way of example, a process for processing raw logs via the data management module. The external world state is recorded directly to the predicate knowledge base. Raw logs 71 from the target system are provided to a data connector 72. The data connector 72 receives the data, digests the data from the document source, such as a document, Google Drive, ftp, stream, websocket, Parquet or Amazon S3, and passes the data in a defined structure data format for processing by other entities, such as the user-based predicate extractor 73.

With respect to the game example, Keboola or other data platform can be used to interchange the data from the user's game, such as via websocket or batches in some storage, into a format defined by the predicate store, including format specifications, connectors, logins, and secrets.

The user-based predicate extractor 73 receives predicate definition raw data and transforms the data given the predicate definition to create predicates from the input log stream. Returning to the game example, the data “Rod1=[disc3, disc2]” is converted to predicates, including disc_on_rod(disc3, rod1), disc_on_rod(disc2, rod1), disc_on_disc(disc2, disc3), smaller(disc2, disc3), disc_clear(disc2).” Once the raw logs are converted into predicate logs 74, another data connector 75 inserts the predicate logs into the predicate knowledge base 76, which res the predicates, including a history of predicates, from the target system. During synthesis, the functionality of the connectors are extended beyond their current functionality by adding preprocessing data transformations relevant to learning the models.

Returning to the discussion with respect to FIG. 4, the model testing and deployment user interface includes the front-end interactive tools that work with the user and includes model development, model-using system development, simulation testing, and deployment. Model development uses a text-based language augmented by a visual programming language. In one embodiment, the modeling language is PDDL text and Blockly provides a visual builder. The user iteratively refines the model through testing and deployment in a digital simulation of the target system or the target system itself. Model debugging tools provide insight and feedback for iterative refinement.

As described above, the models can be synthesized from raw observational data. The interface tools can then be used to manipulate, edit, add, and remove actions within the synthesized model. The goal is a model containing information from domain synthesis on which action to use or not to use for control with the target system. Augmentation refines the models and improves understandability by renaming predicates, goals, and actions as needed. However, use of domain synthesis and LLM (Large Language Model) naming components actually minimizes a number of iterations by the user to create a domain model or the need for user editing, if needed at all. For instance, the use of LLM reduces the need to manually improve action and action parameter names. LLM can also reduce the need to manually write natural language descriptions of the action. In the puzzle example, the system can completely generate proper Towers of Hanoi PDDL from domain synthesis alone and accurate names from the LLM support.

The model-using system development uses a text-based language augmented by a visual programming language. In one embodiment, the system language is text describing a behavior tree and Blockly provides a visual builder. A behavior tree visualizer also provides additional insights. In another embodiment, the user iteratively refines the model through testing and deployment in a digital simulation of the target system or the target system itself. Target application debugging tools can provide insight and feedback for iterative refinement, when applied.

In the game example, the system invokes interfacing with the game to obtain the state of the puzzle, and subsequently, deploys a planner to use the PDDL model to determine action commands in a sequence that solves the provided puzzle. The system then executes the commands on the target game.

Simulation testing via the user interface provides pre-deployment feedback on the system and underlying models in action, while deployment provides the ability to push control by the system and models to the target system. Deployment can also include live performance monitoring of the system in action and supports defining and observing performance through evaluation metrics. The deployment can target any type of cloud and container-based system.

The user interface components rely on core algorithms, including domain synthesis, a Machine Learning (ML)-based predicate extractor, and a large language model (LLM)/ChatGPT-based predicate extractor. During domain synthesis, definitions, pre-processed predicates, user-defined input, existing models, and other information, such as raw logs, are input to synthesis a model that describes the actions that lead from one system state to another. In the game example, domain synthesis can take log data from a human player and develop a PDDL model that solves any Towers of Hanoi puzzle.

The ML-based predicate extractor takes in predicate definitions and pre-processed predicates, and uses auto-ML techniques to extract additional, hard-to-code predicates, from pre-processed predicates, to produce a set of predicates to be fed into a PDDL solver or model. Although the ML-based predicate extractor is not applicable to the game example, the extractor can be applied to a game in which a bunny jumps on platforms higher and higher, where new platforms emerge as the bunny progresses upward.

The game dynamics are usually fully unknown to the observer so the ML-based predicate extractor can be trained on historical data to create a predicate jumpable(platform1, platform2) that will be true if the bunny can jump from platform 1 to platform 2. Complex data can be input into the ML-based predicate extractor, such as platform width, mutual position of the platforms, and the bunny's strength, stamina and speed. Other types of complex data can be used. The result of the input complex data is the predicate.

The LLM/ChatGPT-based predicate extractor performs a similar process as the ML-based predicate extractor, but uses LLM models to extract semantic information from pre-processed predicates. For example, a collection of game-relevant terms which can be transformed into a recommended predicate configuration might include exact prompt wording or LLM model parameters, such as temperature or n_tokens.

During deployed model runtime, deployment setup, description of container images, image registry, relevant services, external endpoints, API's, data locations, and the input stream of target system predicates are input to deploy the model on a cloud-based platform. The deployed model runtime can run on any computer platform, and will run services and let them communicate according to a description given by the system, as well as ingest input data, such as pre-processed predicates, and output data, such as actions that lead to a goal of the target system.

The system output is a stream of actions to be executed on the target system. The form of actions is some high-level plan. However, a user-based action transformer, which is part of the data management module, is responsible for making the plan happen in the real world. In the Towers of Hanoi example, a low-level Azure cloud configuration of individual system components, such as a planner, data store, and serving APIs, networking and interoperability settings, VPNs, container registry settings, and endpoint definitions needed to startup and execute a composed AI system to play the Towers of Hanoi.

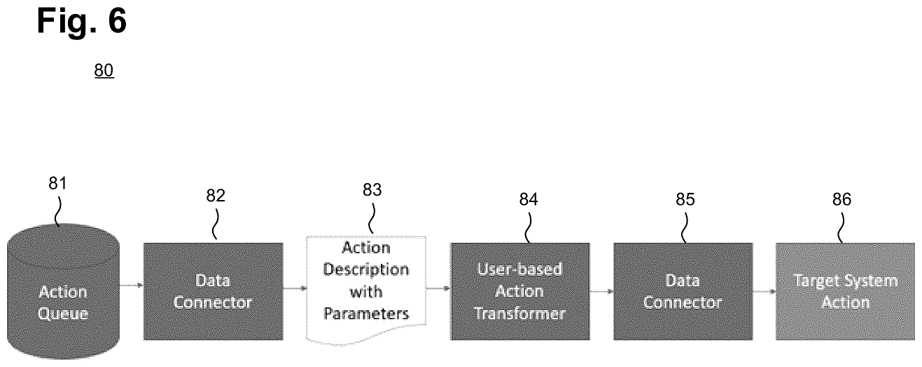

Actions are queued in an action queue and pushed to or read by a data management module. FIG. 6 is a flow diagram showing, by way of example, a process 80 for pushing actions to be executed by the target system. A data connector 82 obtains information from an action queue 81 and converts the data to an action description with parameters 83, which describes actions to be executed in the target system to achieve a desired goal. For instance, in the game example, “move(disc1, disc2, disc3) means to move disc1 from disc2 to disc3. The user-based action transformer 84 receives the set of actions provided by the deployed system and transforms the action from high-level plan steps to low-level execution steps having detailed descriptions of steps to feed into the target system so that all planned actions are performed and executed correctly. A different data connector 85 interfaces with the target platform to execute all action commands 86 on that platform, which affects the state through the actions.

The incremental auto synthesis system utilizes input, such as an optional previous or partial PDDL model with definition of types and hierarchy, such as type names and their sub-type relations, definitions of predicates, including predicate names and types of parameters, and definition of actions. The types can refer to classes of objects that can be used as parameters to predicates and actions. For example, the objects disc1, disc2, and dis3 are associated with type “disc,” while rod1, rod2, and rod3 are associated with type “rod.” The parameters are variables of a function or predicate. For example, a predicate (at ?t—truck?l—location) represents that a truck ?t is in a location ?l(?t and ?l are the parameters of the “at” predicate. In a further example, a predicate titled “on” can have two parameters of type “disc,” representing the object of type “disc,” given as the first parameter, lies on the object of type “disc” provided as the second parameter. The input can also include a collection of change logs, such as lists of observed state transitions. In one embodiment, only the change logs are used as input without a previous PDDL model.

Each change log is provided as a sequence of timestamped entries, where each entry is a list of (grounded) predicates, some of which are true and some which are false. Alternatively, an entry can include a single predicate. Each action can include one or more entries.

A preprocessing task known as log segmentation can be applied to group the entries that belong to the same actions. The grouping can be based on information, such as a value of the timestamp associated with each entry, properties of the predicates, such as name and parameters, labeling on the entries, and action definitions. For example, the action definitions can be provided by the user or via a previous round of incremental synthesis. With respect to the entry labels, entries with different labels belong to different groups. The grouping during log segmentation is solved using the k-medoids algorithm where the distance metric between two entries is defined by the difference of the timestamp values, labels, and the similarity of the predicates in the entries.

Overall, the goal of auto synthesis is to check whether the provided model consistently and completely covers all the provided change logs. If not, the model should be extended by adding missing types, predicates, and/or actions. If the input model is empty, then the synthesis will add all the required types, predicates, and actions needed to cover the provided change logs.

When extending a model or generating a new model, multiple optimization goals are pursued. The goals can include: 1) the number of added actions should be minimal to improve the model's readability and make easy any validations and adjustment by the user; 2) the number of preconditions of the added actions should be larger, rather than smaller. For example, it is better to overapproximate the set of preconditions than under approximate since it is easier for the user to identify and remove superfluous preconditions than add missing ones. Yet, the set of preconditions should not be too large to increase readability by the user and simplicity of the model.

Change logs can differ based on the amounts of information included. Each change log, after log segmentation has been performed, starts with a list of predicates representing an initial state (all predicates are true) followed by a sequence state change, such as what predicates become true and false in a given step or timestamp. An assumption is made that all state changes are fully observed and a state trajectory can be trivially reconstructed to capture the sequence of states that were observed in a dynamic system and recorded in the corresponding change log.

Information about state changes can be enriched by information about actions that caused the state changes. Specifically, classes of changelogs can differ on how much information is provided about the actions. For example, L2 class includes full information about actions that made particular state changes, such as action names (labels) accompanied by an ordered list of parameters representing objects the given action manipulated, while L1 class include only information about action names (labels) of actions that made particular state changes. An L0 class may not contain any information about actions responsible for particular state changes, so the change logs include only information about state changes, and an L-1 class includes information about timestamps in which predicates are achieved or deleted by there is no distinction of atomicity of state changes, such as state changes caused by individual actions. Yet, no information about actions that are responsible for state changes may be present.

Provided below is a sample changelog for the problem regarding solving the Towers of Hanoi. The changelog is an L2 class of logs. However, removing the action arguments in italics amends the changelog to an L1 class, while taking out action names, which are underlined, and the action arguments in italics, amends the changelog to the L0 type. Additionally, removing the “NEXT-STATE” separator makes the changelog an L-1 class of logs. Lines that include the phrase “PRECONDITION-HINT” are optional and can appear in all classes of logs.

### Changelog

2023-11-04 14:23:41 968; 100; (smaller d2 d3); init
2023-11-04 14:23:41 968; 100; (smaller d3 peg3); init
2023-11-04 14:23:41 968; 100; (on d2 d3); init
2023-11-04 14:23:41 968; 100; (smaller d1 d2); init
2023-11-04 14:23:41 968; 100; (smaller d2 peg2); init
2023-11-04 14:23:41 968; 100; (smaller d2 peg1); init
2023-11-04 14:23:41 968; 100; (smaller d3 peg2); init
2023-11-04 14:23:41 968; 100; (smaller d3 peg1); init
2023-11-04 14:23:41 968; 100; (on d1 d2); init
2023-11-04 14:23:41 968; 100; (smaller d1 peg3); init
2023-11-04 14:23:41 968; 100; (on d3 peg1); init
2023-11-04 14:23:41 968; 100; (clear peg3); init
2023-11-04 14:23:41 968; 100; (clear d1); init
2023-11-04 14:23:41 968; 100; (smaller d1 peg2); init
2023-11-04 14:23:41 968; 100; (smaller d1 peg1); init
2023-11-04 14:23:41 968; 100; (clear peg2); init
2023-11-04 14:23:41 968; 100; (smaller d1 d3); init
2023-11-04 14:23:41 968; 100; (smaller d2 peg3); init
2023-11-04 14:23:41 968; 100; NEXT-STATE;
2023-11-04 14:23:41 968; 101; PRECONDITION-HINT; (smaller d1 peg3) move peg3 d1 d2
2023-11-04 14:23:41 968; 101; PRECONDITION-HINT; (on d1 d2); move peg3 d1 d2
2023-11-04 14:23:41 968; 101; PRECONDITION-HINT; (clear d1); move peg3 d1 d2
2023-11-04 14:23:41 968; 101; PRECONDITION-HINT; (clear peg3); move peg3 d1 d2
2023-11-04 14:23:41 968; 101; (on d1 peg3); move peg3 d1 d2
2023-11-04 14:23:41 968; 101; (clear d2); move peg3 d1 d2
2023-11-04 14:23:41 968; 101; (not (on d1 d2)); move peg3 d1 d2
2023-11-04 14:23:41 968; 101; (not (clear peg3)); move peg3 d1 d2
2023-11-04 14:23:41 968; 101; NEXT-STATE;
2024-01-26 12:00:00 000; 102; PRECONDITION-HINT; (smaller d2 peg2) move peg2 d2 d3
2024-01-26 12:00:00 000; 102; PRECONDITION-HINT; (on d2 d3); move peg2 d2 d3
2024-01-26 12:00:00 000; 102; PRECONDITION-HINT; (clear d2); move peg2 d2 d3
2024-01-26 12:00:00 000; 102; PRECONDITION-HINT; (clear peg2); move peg2 d2 d3
2023-11-04 14:23:41 968; 102; (on d2 peg2); move peg2 d2 d3
2023-11-04 14:23:41 968; 102; (clear d3); move peg2 d2 d3
2023-11-04 14:23:41 968; 102; (not (on d2 d3)); move peg2 d2 d3
2023-11-04 14:23:41 968; 102; (not (clear peg2)); move peg2 d2 d3
2023-11-04 14:23:41 968; 102; NEXT-STATE;
2024-01-26 12:00:00 000; 103; PRECONDITION-HINT; (smaller d1 d2); move d2 d1 peg3
2024-01-26 12:00:00 000; 103; PRECONDITION-HINT; (on d1 peg3); move d2 d1 peg3
2024-01-26 12:00:00 000; 103; PRECONDITION-HINT; (clear d1); move d2 d1 peg3
2024-01-26 12:00:00 000; 103; PRECONDITION-HINT; (clear d2); move d2 d1 peg3
2023-11-04 14:23:41 968; 103; (on d1 d2); move d2 d1 peg3
2023-11-04 14:23:41 968; 103; (clear peg3); move d2 d1 peg3
2023-11-04 14:23:41 968; 103; (not (on d1 peg3)); move d2 d1 peg3
2023-11-04 14:23:41 968; 103; (not (clear d2)); move d2 d1 peg3
2023-11-04 14:23:41 968; 103; NEXT-STATE;
2024-01-26 12:00:00 000; 104; PRECONDITION-HINT; (smaller d3 peg3) move peg3 d3 peg)
2024-01-26 12:00:00 000; 104; PRECONDITION-HINT; (on d3 peg1); move peg3 d3 peg)
2024-01-26 12:00:00 000; 104; PRECONDITION-HINT; (clear d3); move peg3 d3 peg)
2024-01-26 12:00:00 000; 104; PRECONDITION-HINT; (clear peg3); move peg3 d3 peg)
2023-11-04 14:23:41 968; 104; (on d3 peg3); move peg3 d3 peg)
2023-11-04 14:23:41 968; 104; (clear peg1); move peg3 d3 peg)
2023-11-04 14:23:41 968; 104; (not (on d3 peg1)); move peg3 d3 peg)
2023-11-04 14:23:41 968; 104; (not (clear peg3)); move peg3 d3 peg)
2023-11-04 14:23:41 968; 104; NEXT-STATE;
2024-01-26 12:00:00 000; 105; PRECONDITION-HINT; (smaller d1 peg1); move peg) d1 d2
2024-01-26 12:00:00 000; 105; PRECONDITION-HINT; (on d1 d2); move peg) d1 d2
2024-01-26 12:00:00 000; 105; PRECONDITION-HINT; (clear d1); move peg) d1 d2
2024-01-26 12:00:00 000; 105; PRECONDITION-HINT; (clear peg1); move peg) d1 d2
2023-11-04 14:23:41 968; 105; (clear d2); move peg) d1 d2
2023-11-04 14:23:41 968; 105; (on d1 peg1); move peg) d1 d2
2023-11-04 14:23:41 968; 105; (not (on d1 d2)); move peg) d1 d2
2023-11-04 14:23:41 968; 105; (not (clear peg1)); move peg) d1 d2
2023-11-04 14:23:41 968; 105; NEXT-STATE;
2024-01-26 12:00:00 000; 106; PRECONDITION-HINT; (smaller d2 d3); move d3 d2 peg2
2024-01-26 12:00:00 000; 106; PRECONDITION-HINT; (on d2 peg2); move d3 d2 peg2
2024-01-26 12:00:00 000; 106; PRECONDITION-HINT; (clear d2); move d3 d2 peg2
2024-01-26 12:00:00 000; 106; PRECONDITION-HINT; (clear d3); move d3 d2 peg2
2023-11-04 14:23:41 968; 106; (on d2 d3); move d3 d2 peg2
2023-11-04 14:23:41 968; 106; (clear peg2); move d3 d2 peg2
2023-11-04 14:23:41 968; 106; (not (on d2 peg2)); move d3 d2 peg2
2023-11-04 14:23:41 968; 106; (not (clear d3)); move d3 d2 peg2
2023-11-04 14:23:41 968; 106; NEXT-STATE;
2024-01-26 12:00:00 000; 107; PRECONDITION-HINT; (smaller d1 d2); move d2 d1 peg)
2024-01-26 12:00:00 000; 107; PRECONDITION-HINT; (on d1 peg1); move d2 d1 peg)
2024-01-26 12:00:00 000; 107; PRECONDITION-HINT; (clear d1); move d2 d1 peg)
2024-01-26 12:00:00 000; 107; PRECONDITION-HINT; (clear d2); move d2 d1 peg)
2023-11-04 14:23:41 968; 107; (on d1 d2); move d2 d1 peg1
2023-11-04 14:23:41 968; 107; (clear peg1); move d2 d1 peg1
2023-11-04 14:23:41 968; 107; (not (clear d2)); move d2 d1 peg1
2023-11-04 14:23:41 968; 107; (not (on d1 peg1)); move d2 d1 peg1
2023-11-04 14:23:41 968; 107; NEXT-STATE;

From the changelogs, all the existing predicate names and numbers of their parameters are known. However, the types of parameters remain unknown, unless the predicate is provided in the partial input model. To determine parameter types, the following algorithm can be used. A type A can be a subtype of B:A ⊏ B. Given the subtype relation, A is more specific than B, B is less specific than A, B is more general than A, and A is less general than B. A valid subtype relation should satisfy a set of conditions, including: 1) antisymmetric, where if A is a subtype of B and B is a subtype of A, then A and B are equal: A⊏ B∧B⊏ A⇒A=B; 2) transitive, where the subtype relation is transitive: A⊏ B∧B⊏ C⇒A⊏ C; 3) each type has a unique immediate super type with no multiple inheritance: ∀A:A=root∧∃B:(A⊏ B)∧(∀C:A⊏ C⇒B⊏ C); and 5) there is a most general type (unique root of the type hierarchy) named “object.”

During an input transformation stage, a bipartite graph from the log that includes all information relevant to type synthesis is created. Each parameter position in an action or predicate is considered a slot. For example, the predicate can be (smaller ?d1-disc ?d2-disc), which is true if the value of ?d1 is smaller than the value of ?d2, has two slots. Generally, the predicate represents a relation between objects, such as disc ?d1 being smaller than disc ?d2. From the logs, a set of objects that occur is extracted, as well as slots in which each object is used. The determination of whether an object is used in a slot or not is determined, and the frequency of an object in use is not necessary. Thus, the relation between slots and objects forms a bipartite graph, or a list of tuples describing such a graph, with objects on the left and slots on the right, slots and objects together form the set of nodes V. There is an edge between an object and a slot if and only if that object is used in that slot at least once in the log.

The goal is to identify a set of types and a valid subtype relationship of the types. Each slot and object can be assigned a type, such that if (object, slot) appears in the input, then the type of object is at least as specific as the type of slot.

A type hierarchy can be built by starting from the bipartite input graph G. V represents nodes of the graph, while E represents edges of the graph. D is a set of subsets of V that can be constructed. For each C∈D, a type T_{c} is created. C represents a subset of the vertices of V. There is a one-to-one correspondence between elements in D and their types, such that for two subsets C, C′∈D, the following is true:

$${T}_{{C}^{′}} ⊆ {T}_{C} ⇔ {C}^{′} ⊆ C$$

For V∈D, type Tᵥ is the most general type of object. The other elements of D are constructed by finding all connected components of the graph G, using union find, and adding the set C of all vertices in the connected component to D. A connected component is a subgraph where every node is connected to every other node in the subgraph via a path, such as a sequence of edges. For each component, the slot with the most incident edges is removed from the graph G. For example, given a most used slot within a C∈D, an assumption is made that the slot must get the most general type of all types used in the group. The type can be T_{c} and by construction, all other slots will get a more specific type. After removing nodes belonging to the most used slots, the algorithm can be repeated by finding all connected components in the remaining graph, adding the set of all vertices in the connected component to D, and removing the node belonging to the most used slot.

Connected components found in one repetition of the algorithm are subsets of the connected components found in the previous repetition of the algorithm. Thus, the resulting type hierarchy satisfies the required conditions.

Slots get assigned the type of the connected component they belonged to before being removed. Objects get assigned the most specific type of all slots they appear in. All slots in which an object appears, must end up in the same connected component and the types will be placed in a single chain. If a simple, flat type hierarchy is desired, the algorithm can be terminated after identifying the first set of connected components.

As many types as there are slots are created with long chains of types that do not have a split. To simplify the type of hierarchy, all types that are on a chain are unified, such that all types that have multiple subtypes remain, while all types with only a single subtype get removed. The types assigned to objects and slots are updated accordingly.

With respect to naming the types, an LLM can be used to give meaningful and human friendly names to the generated types. The LLM can be provided with the names and asked to summarize the names into a short phrase.

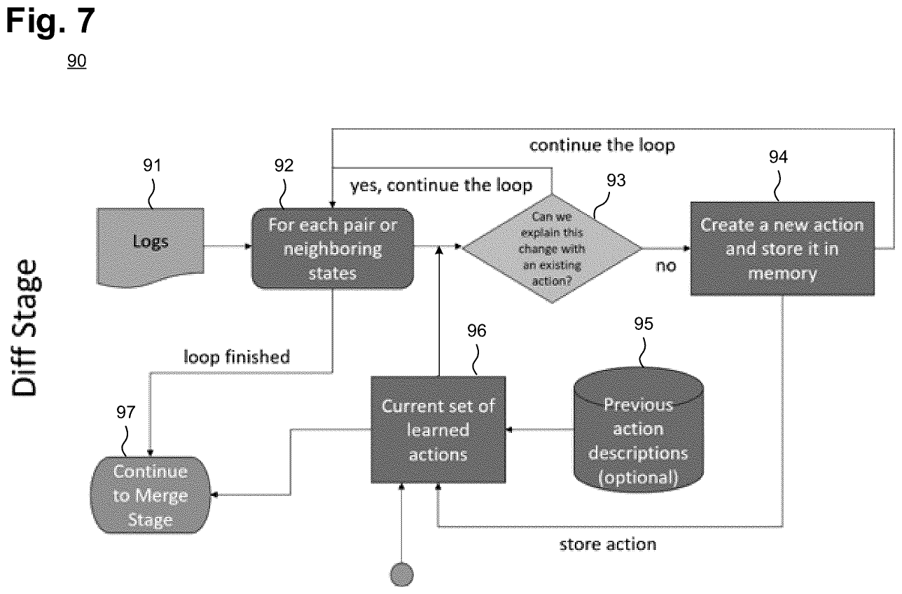

The actions for the model can be generated using diff, merge, and refine stages. FIG. 7 is a flow diagram showing, by way of example, a process 90 of the diff stage for generating actions. During the diff stage, an initial set of lifted actions is constructed. A list of ground actions is first generated based on neighboring states 92 from the logs 91. For example, there is a transition from state S to S′ and set of predicates A was added, while set of predicates B is removed. The ground action for this transition is generated with: 1) effects: add A, remove B; 2) preconditions: all the ground predicates in S that share all their parameters with any predicate in A or B (other heuristics are possible, which are offered to be implemented in the Refine stage discussed in detail below); and 3) parameters: all the parameters occurring in the preconditions and effects. In one embodiment, the logs can be received in the proper order or alternatively, the log files may require ordering to organize actions in proper sequence.

For each change, a determination is made whether the change is explained with an existing action 93 and if not, create a new action and store the new action in memory 94. However, if the change can be explained, then continue to the next change. The existing action can be identified by descriptions 95 and the actions if they explain a change can be included in a set of learned actions 96 with any new actions.

The ground actions are lifted 94 and normalized, and collected into a set of distinct lifted actions. Lifting focuses on generalization of the actions, such as by replacing each object with a variable. For example, a ground (or grounded) action can be “pickup disc3” and a corresponding lifted action can be “pickup an object of type disc.” When normalized, the parameters are renamed, while the preconditions, effects and parameters are reordered, which removes symmetries and allows recognition of cases when several ground actions belong to the same lifted action. Also, the normalized lifted actions are collected into a set data structure so duplicates are filtered automatically.

In comparison to theoretically optimal learned action, there may be differences of missing effects, such as when the add (remove) effect was already true (false) in S′. Alternatively, or in addition, to missing effects, missing and extra conditions can exist due to the heuristic selection of preconditions. Negative preconditions and precondition predicates with no parameters can be missing at times. Finally, parameters can also be missing due to missed effects and preconditions.

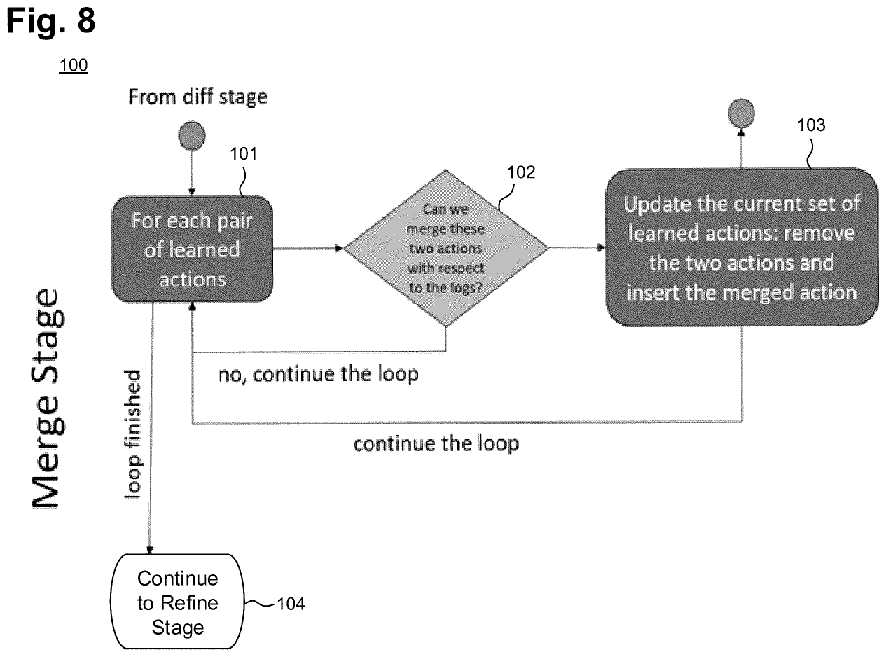

Learned actions from the diff stage can enter the merge stage, which aims to reduce a number of the learned actions and improved accuracy of the learned actions by adding missing effects and reducing a number of incorrect preconditions. Specifically, pairs of actions learned in the diff stage can be merged. For example, two actions A1 and A2 can be merged if there is an action A12 that each grounded occurrence of A1 and A2 in the input logs can be replaced by a grounded instance of A12, which is often satisfied when the set of effects of one action is a subset of the set of effects of the other action. FIG. 8 is a flow diagram showing, by way of example, a process 100 for performing the merge stage. Pairs of learned actions are paired 101 and a determination is made as to whether the two actions in the pair can be merged with respect to the log 102. The actions can be merged when it is possible to replace the two actions with a single action. If no, then a different pair of learned actions is reviewed. However, if yes, then the pair of actions is merged and the current set of learned actions is updated 103 by removing the two actions and by inserting the merged action.

When merging two actions, the new action's set of effects is defined as the union of the effects of the two actions, and the set of preconditions is defined as the intersection of preconditions of the two actions. The parameters of the merged action are computed from the preconditions and effects by taking all the variables and constants that appear in them. Also, the merged action replaces the two actions from which the merged action was created.

A particular order can exist for merging the actions by using the low-hanging fruit algorithm to improve performance. First, actions with identical effects can be merged. Effects are determined to be identical when they differ only in preconditions. The identical effects can be easy to detect, and quickly and drastically reduces a number of actions for the next stages. Next, actions where the effects of one are a subset of the effects of another can be merged. Finally, the remaining actions that can be merged are completed.

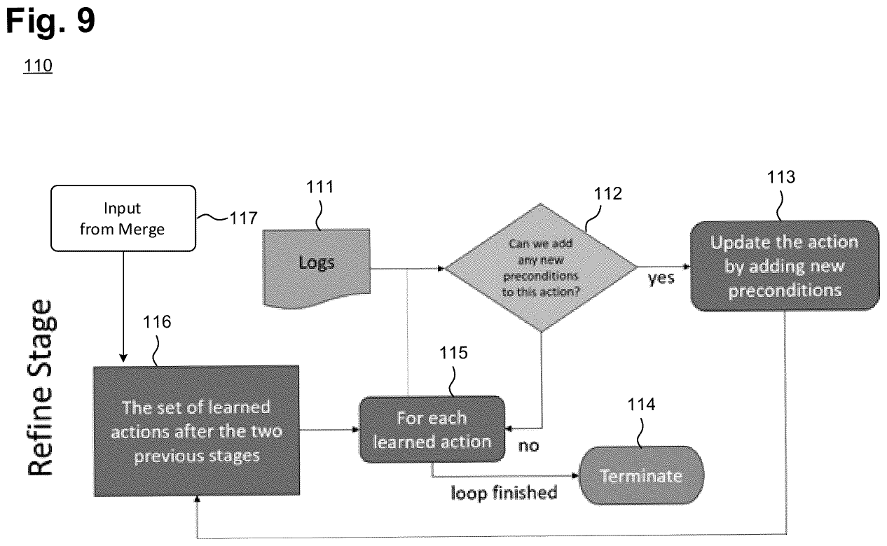

The merged actions are provided to the refine stage, which improves the generated actions by adding predicates into their preconditions. FIG. 9 is a flow diagram showing, by way of example, a process 110 for performing the refine stage. Using input from the merge stage 117 and information from the logs 111, a determination is made as to whether any new conditions can be added 112 to the actions from the merge stage. If so, the action is updated by adding the new preconditions 113 and saving the updated action in a set of learned actions 116. If not, another learned action 115 is reviewed to determine whether preconditions should be added. Once all the actions have been reviewed, the process terminates 114.

The refine stage can be redundant depending on the heuristics used in the first stage when selecting an initial set of preconditions. The heuristics used at this stage include add all predicates that are true in each state that precedes the execution of the given action. Rigid predicates that are constant and unchanging must be handled carefully, otherwise the rigid predicates will end up in the preconditions of all actions. Predicates are added that share at least one parameter with the set of parameters in the effect predicates. Also, a probability of a predicate to be a preconditions of an action can be computed based on how often the given predicate appears in the observed world state. Predicates that are rare are more likely to be preconditions of actions for which they are always present in their preceding states.

The diff, merge, and refine stages are performed when starting with an empty set of actions. For incremental usage, when some actions are already given in the input, modifications are made to each of the diff, merge, and refine stages. For instance, in the diff stage, the change is matched with a grounding of one of the given actions and if a match cannot be found, a new action is generated as described above with respect to FIG. 7. In the merge stage, the input actions are not considered since they should be preserved in their original form, while in the refine stage, when preconditions are added to the input actions, the added predicates are marked when presenting the results so the user can easily recognize and validate the changes. Also, the user is notified if any of the input actions never matched any of the changes in the logs. In such a case, the given input action may be unnecessary and can be deleted.

Returning to the Towers of Hanoi game, a sample changelog from playing the game with three pegs and three discs is provided below:
1966-07-30 08:30:00 [(smaller d1 d2) (smaller d1 d3) (smaller d2 d3) (smaller d1 peg1)(smaller d2 peg1) (smaller d3 peg1) (smaller d1 peg2) (smaller d2 peg2)(smaller d3 peg2) (smaller d1 peg3) (smaller d2 peg3) (smaller d3 peg3) (on d3 peg1) (on d2 d3) (on d1 d2) (clear d1) (clear peg2) (clear peg3)]
1966-07-30 08:30:20 [(clear d2) (on d1 peg3) (-on d1 d2) (-clear peg3)]
1966-07-30 08:30:37 [(clear d3) (on d2 peg2) (-on d2 d3) (-clear peg2)]
1966-07-30 08:30:55 [(clear peg3) (on d1 d2) (-on d1 peg3) (-clear d2)]

The changelog is in a correct format and does not require segmentation. Specifically, the changelog includes four entries, each with a timestamp and list of predicates that change at the specified time. There are three types of predicates displayed in the changelog, including: (smaller ?argument1 ?argument2), (on ?argument1 ?argument2), and (clear ?argument1). The set of objects in the change log are: d1, d2, d3, peg1, peg2, peg3.

Since all of the objects are used at least once as an argument of the predicate clear, the objects can be determined to have the same type, which can be labeled as type discOrPeg. The type declarations can be added to the predicate definitions.

Once the predicates and types of objects in the problem are known, the actions can be synthesized. The problem identified in the game example is how to solve the Towers of Hanoi game. Based on the second line of the changelog, the changes are identified as (clear d2) (on d1 peg3) (-on d1 d2) (-clear peg3). The changes identify the effects of the learned action as follows:
:effect(and
   not(clear(peg3))
   not(on(d1, d2))
   clear(d2)
   on(d1, peg3))

To compute the preconditions of this action, an action that moves disc d1 from being on top of disc d2 onto peg3, the predicates that include all the objects from the set of objects occurring in the effects, such as peg3, d1, and d2, are taken to yield: (smaller d1 d2) (smaller d1 peg3) (smaller d2 peg3) (on d1 d2) (clear d1) (clear peg3), and will become preconditions of the generated action:

```
(:action a0
  :precondition(and
      (smaller d1 d2)
      (smaller d1 peg3)
      (smaller d2 peg3)
      (on d1 d2)
      (clear d1)
      (clear peg3))
    :effect(and
      not(clear(peg3))
      not(on(d1, d2))
      clear(d2)
      on(d1, peg3))
)
```

Next, the action should be lifted and normalized. During lifting, each object is replaced with a variable. During normalization, the predicates and variable names (for example, lexicographically) are sorted to remove symmetries. After lifting and normalizing, the following action is generated:

```
(:action a0
  :parameters(?disc-1 ?disc-2 ?disc-3 - discOrPeg)
  :precondition(and
    clear(?disc-1)
    clear(?disc-2)
    on(?disc-2, ?disc-3)
    smaller(?disc-2, ?disc-3)
    smaller(?disc-2, ?disc-1))
    smaller(?disc-3, ?disc-1)
  :effect(and
    not(clear(?disc-1))
    not(on(?disc-2, ?disc-3))
    clear(?disc-3)
    on(?disc-2, ?disc-1))
)
```

The lifting and normalizing are performed on the remaining state transitions to get the following action for all remaining state transitions in which the action is involved:

```
(:action a1
  :parameters(?disc-1 ?disc-2 ?disc-3 - discOrPeg)
  :precondition(and
    clear(?disc-1)
    clear(?disc-2)
    on(?disc-2, ?disc-3)
    smaller(?disc-1, ?disc-3)
    smaller(?disc-2, ?disc-1)
    smaller(?disc-2, ?disc-3))
  :effect(and
    not(clear(?disc-1))
    not(on(?disc-2, ?disc-3))
    clear(?disc-3)
    on(?disc-2, ?disc-1))
)
```

Actions a0 and al are similar, but they differ since a0 has smaller(?disc-3, ?disc-1), while al has smaller(?disc-1, ?disc-3). The two actions can enter the merge phase, and since both actions have the same effects, the actions can be merged. The merged action will inherit the set of effects from the two actions. The set of preconditions will be the intersection of the sets of preconditions of the two actions. The merged action appears below:

```
(:action m01
  :parameters(?disc-1 ?disc-2 ?disc-3 - discOrPeg)
  :precondition(and
    clear(?disc-1)
    clear(?disc-2)
    on(?disc-2, ?disc-3)
    smaller(?disc-2, ?disc-1)
    smaller(?disc-2, ?disc-3))
  :effect(and
    not(clear(?disc-1)
    not(on(?disc-2, ?disc-3))
    clear(?disc-3)
    on(?disc-2, ?disc-1))
)
```

More human friendly names can be determined for the actions using an LLM model, which can be provided with PDDL definitions of the action and predicates. For example, the action “move” can be changed to “move-disc.” In this example, the refine stage would not add any new preconditions to the single learned action and thus, synthesis would terminate.

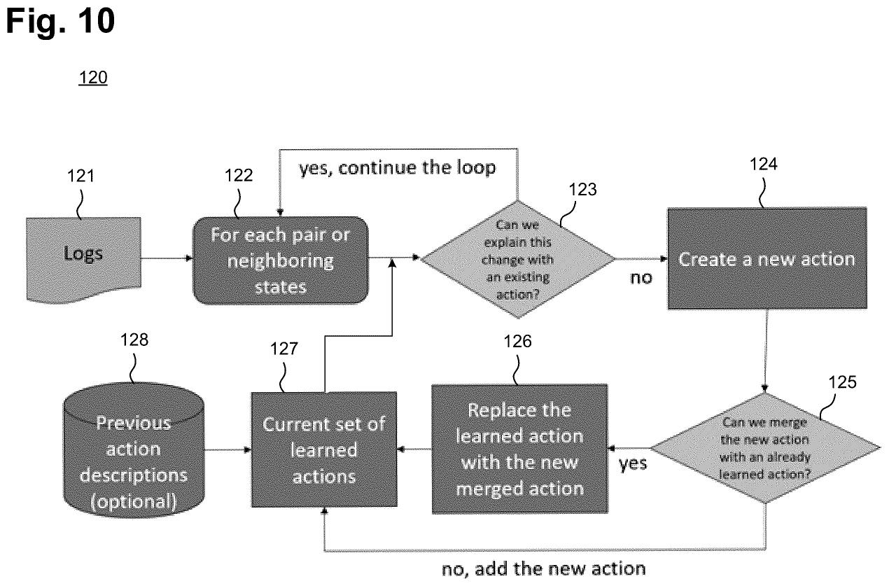

Instead of using the diff, merge, and refine stages, a match or spawn process can be used. FIG. 10 is a flow diagram showing, by way of example, a process 120 for performing match or spawn. The match or spawn process scans the logs 121 sequentially and for each pair of neighboring states 122, a change is compared to an existing lifted action in the model to see if a match exists. If the change cannot be matched to any existing actions, then a new actions is spawned 124 and added to the model. A check is performed to see if the newly spawned action can be merged with an existing action 125 and if so, the learned action is replaced with the new merged action 126. However, if the new action cannot be merged, the new action is added to the current set of learned actions 127, which is associated with previous action descriptions 128. If the change can be explained by an existing action, the next pair of neighboring states is processed.

The match or spawn process addresses the issue of the diff, merge, and refine process regarding expensive merge and refine phases by preliminary merging the spawned action as the logs are scanned instead of doing it in a separate stage. Unlike the diff, merge, define process, the match or spawn process has only a single stage and is intrinsically incremental.

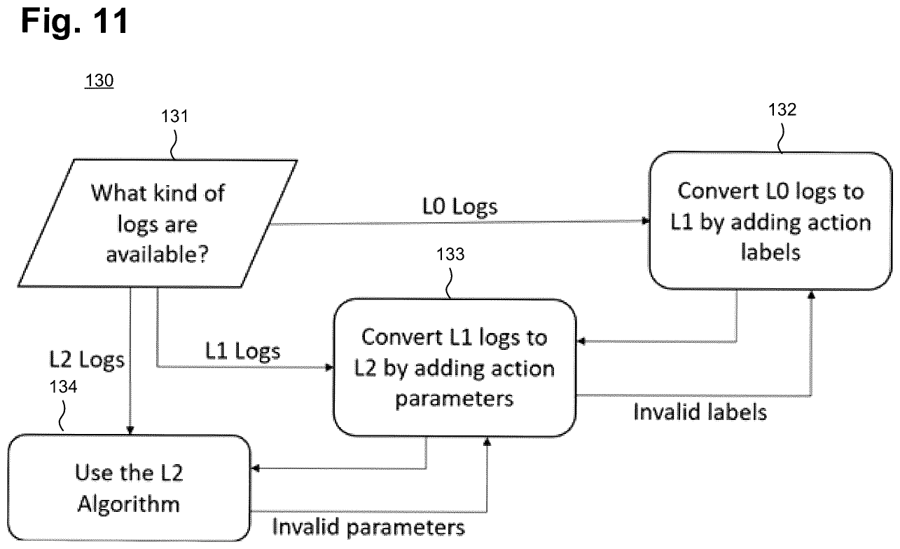

Different classes of logs exist based on an amount of information the logs contain. When using the top-down synthesis (TDS) algorithm, the easiest log is identified and processed. For example, the L2 class is simple and includes more information than lower-level logs and allows for better and more accurate model synthesis. FIG. 11 is a flow diagram showing, by way of example, a process 130 for converting logs prior to processing. A determination is made as to what kind of logs are available 131. When L2 logs are available, an L2 algorithm for synthesis is performed 134 on the log. If only L1 logs are available, the L1 logs can be converted or elevated 133 to L2 logs by synthesizing missing information, including the parameters of the grounded actions, and applying an L2 synthesis algorithm to obtain a domain model.

Similarly, if the available logs are classified as L0 class, then the L0 logs can be converted or elevated 132 to L1 logs by computing the missing information, such as the action names for each transition, and then applying the method for handling L1 logs. In general, elevating logs, such as from L0 to L1 and L1 to L2, can be performed in different ways and involves heuristic decisions.

An L2 log includes full information about the action that made a particular state change, including storing the action's label and an ordered list of arguments, which are the objects that the action manipulated. The state changes, or transitions, are grouped by their respective action labels. Each action is synthesized in isolation based on transitions with a common label. Let T_{L} be the set of transitions with the same label L, which will be used together to synthesize a single action. Each transition carries with it the label L, an argument list A, and is from a before-state S to an after-state T, which are sets of ground predicates, such as predicate symbols applied to objects.

To synthesize an action for the label L, a list of parameters P of length matching that of the argument lists for that label (all transitions for label L necessarily agree on this length) is fixed. Appropriate add (add) and delete (del) effects, as well as preconditions (pre) need to be determined. The add and delete effects and preconditions are going to be sets of predicate symbols applied to the parameters from P. Each of the observed transitions from T_{L} must be explained in the following sense. Let σ be a substitution mapping the parameters from P to the arguments of A (in order). Then, for every f∈pre, fσ holds in S and that:

$$T = ( S \backslash \{ e σ \vert e ∈ del \} ) ⋃ \{ e σ \vert e ∈ add \} .$$

The L2 synthesis algorithm includes three phases regarding synthesizing the add and delete effects. In the first phase, for every transition in T_{L} and every observed state change, all the possible add/delete effect candidates that could explain the change are collected. In a second phase, the candidates are pruned and those which are incompatible with some other transition in T_{L} are discarded. Finally, a small set of add and delete effects from the remaining candidates are selected so no observed state change remains unexplained.

For every transition in T_{L} and every fact that was observed as added f∈T\S, a set of explanation candidates are generated, where the set of explanation candidates are explain_{f}={f|f σ=f}, and f and f share the predicate symbol, but the candidates f apply the symbol to parameters from P, and σ is as above. All the explain sets are collected over all transitions and all observed added facts in set (of sets) called meas_{L} (for must-explain-adds). The set meds_{L} (must-explain-dels) is formed to explain all the observed deletions.

In a second phase, the candidate explanations, which are disconfirmed by some other transition in T_{L} are pruned. For additions, given any f′∈explain_{f}∈meas_{L} if there is a transition for which f′σ∉T, such a candidate shall be pruned. Deletions are analogous. Pruning is done in another pass through all the transitions. Disconfirmations are only sought for those add/delete effects which have been speculated as explanations, which reduces an amount of work needed.

The third phase uses the pruned meas_{L} and medS_{L} sets to finally synthesize the add and delete effects for the action with label L. The third phase relies on a minimality principal, trying to introduce as few effects as possible while guaranteeing to explain all the observations, which is performed in a heuristic fashion, iteratively committing to one effect at a time. In an example, for adding since deleting in analogous, start with add=Ø. Then, as long as there is an expl∈meas_{L} such that expl ∩ add=Ø In, and an effect f∈U meas_{L}, which maximizes the size of {expl∈measₗ|expl ∩ add=Ø and f∈expl}, breaking ties arbitrarily, is selected. Then, add f to add to set add:=add ∪ {f}.

To determine the preconditions of an action, the set of potential preconditions for each transition is formed and an intersection of the set is determined. Also, to build the set of potential preconditions, the set of non-negated ground predicates in the before state that only use objects that are used as parameters of the action are considered. An inverse of the substitution mapping action parameters is applied to objects to get the potential preconditions. The substitution may not be injective and thus, there may be multiple possible inverse values. All possible combinations of the inverse values can be created.

### Elevating L1 Logs to L2 Logs

In L1 logs, there are no argument lists supplied with a transition, so a transition only consists of the action label L, a before-state S, and an after-state T. The extra challenge, compared to working with L2 logs, therefore, comes from the need to additionally synthesize the exact form of σ, the substitution mapping in each transition of the action's parameters to concrete objects. The number of parameters of each action should be determined.

Like with the L2 logs, the L1 synthesis algorithm groups transitions according to the action label L into sets of transitions TL and works with each group separately. To determine the initial number of parameters for an action with label L, the L1 synthesis algorithm scans the transition in TL and counts a number of distinct objects that are arguments to predicates getting added or deleted in each, such as either the arguments if f∈T\S or if f∈S\T. A maximum count over all transitions can be taken as the initial number of parameters. If, during the follow-up steps, this number of parameters gets recognized as insufficiently small and can be increased by one and the whole process restarts. A heuristic bound on the number of such increases can be imposed upon the reaching of which the synthesis attempt is abandoned and the user gets notified.

To speculate the exact form of separately for every transition in TL and to be able to backtrack over the main decisions regarding the action's add and delete effects to synthesize, the L1 algorithm is built around an encoding of the associated problem into propositional logic. The L1 algorithm uses a dedicated tool, called a SAT solver, to search for the synthesis solution.

The encoding process is incremental to maintain efficiency. The process alternates between a speculation phase, which initially focuses on a single transition only, and a verification phase, in which all other transitions are scanned and checked for compatibility with the speculated solution. If a transition is found incompatible, it is added to the set of transitions entering the speculation phase. A second important design choice, which is conceptually shared with the L2 synthesis algorithm, but manifests in its own way, is to first focus on explaining what is changing in a transition and only later, lazily, express what does not change and should therefore be excluded from the speculated solution space.

The encoding works with two basic sets of propositional variables; however, other variables, such as auxiliary variables, can be used as well. The first set describes the shape of σ in the following way: for every parameter pi we have the variables bind(t, pᵢ, oⱼ), where oⱼ ranges over all the objects and encodes that σ(pᵢ)=oⱼ is for transition t∈T_{L}. For every pᵢ and for every t∈T_{L} exactly one bind(t, pᵢ, oⱼ) should be true.

The second set contains variables of the form add(pred, pᵢ, . . . ) and del(pred, pᵢ, . . . ) for every predicate pred among the facts in T\S and S\T, respectively, and for every vector of formal parameters pᵢ, . . . of a length corresponding to the number of arguments pred expects. Unlike the bind variables, these variables are not indexed by transition t∈T_{L}, s their meaning is for the whole action L to be synthesized and therefore, non-local. To explain an observed addition of one predicate, for example of pred(a, b)∈T\S for some transition t, the encoding contains the formula:

$$∨ add ( pred , {p}_{i} , {p}_{j} ) ∧ bind ( t , {p}_{i} , a ) ∧ bind ( t , {p}_{j} , b ) ,$$

where the big disjunction is over all the possible vectors of available parameters of length two.

To exclude a speculation solution which conflicts with an observed non-change, the following example is provided. A true variable add(pred, p₁, p₂) in the tentative solution assignment exists, along with, for example, bind(t, p₁, a) and bind(t, p₂, b) set true as well, while the corresponding ground fact of pred(a, b) is not in T formula to the encoding for some transition t∈T_{L}. The following formula is then added to the encoding:

$$¬ add ( pred , {p}_{1} , {p}_{2} ) ∨ ¬ bind ( t , {p}_{1} , a ) ∨ ¬ bind ( t , {p}_{2} , b )$$

A request is made to the SAT solver for a different solution. The process of lazily correcting the solution is performed until inconsistencies with the observations in transitions remain.

Returning to the distinction between the speculation phase and the verification phase, the SAT solver is free to choose values for any variable to satisfy given formulas during the speculation phase. However, for the verification phase, a solution to the variables of the form add(pred, pᵢ, . . . ) and del(pred, pᵢ, . . . ) is fixed and supplied as unit clause assumptions. A determination is made as to given the currently encoded global solution to the action's add and delete effects whether there is a location solution in terms of the substitution σ for another transition t∈T_{L}. To further improve the efficiency of the algorithm, the speculation phase is ended before moving to the verification phase by explicitly minimizing the solution and aiming for a small number of variables in the form add(pred, pᵢ, . . . ) and del(pred, pᵢ, . . . ) to be set to true.

Once the add and delete effects for an action are synthesized, along with the associated parameter to argument mappings σ, preconditions can be synthesized as described for the L2 logs. However, preconditions may need additional action parameters that are not used for any effect. Thus, additional parameters may need to be added. Whether additional parameters are needed is determined using the PRECONDITION-HINT; lines in the log file.

An attempt is made to explain precondition predicates using the same method used for explaining addition predicates, with the only difference using pre(pred, pᵢ, . . . ) variables instead of add(pred, pᵢ, . . . ). During the process, additional parameters can be added. To account for the substitution σ that was found to explain the addition and deletion of predicates, the values of the bind(t, pᵢ, oⱼ) variables are fixed accordingly and the formula is simplified. In contrast to the addition and deletion of predicates, the predicates are not considered all at once. Rather, the predicates are considered one at a time. If the process fails for one of the predicates, the precondition hint will be ignored and no new parameters will be added. Once the process is complete, preconditions can be synthesized as described for the L2 logs.

### Elevating L0 Logs to L1 Logs

To obtain L1 logs from L0 logs, action labels need to be added to the observed transitions, which is the same as grouping them such that each group includes transitions that are explained by a single action. One way to group the transitions is by their signatures. The signature of a transition is defined by the names of the predicates and negated predicates in the transition. For an example, consider the line entry of the logs from the Towers of Hanoi example: (clear d2) (on d1 peg3) (-on d1 d2) (-clear peg3).

The transition described from the log entry yields the following signature: {clear, on, -on, -clear}. Transitions with an identical signature can be grouped together and get the same label assigned. This is one example of one way to group and label the transitions, and other methods are possible. Also, in one embodiment, transitions with different signatures can be grouped together, for example, when one signature is a subset of another one.

If a different embodiment, there may be an advantage to not grouping together the transitions with the same label, such as for actions that have identical effects, but distinct preconditions. An example is movement on a grid graph with actions, described below:

```
(:action move-up
  :parameters(?from ?to - location)
  :precondition(and
      at(?from)
      above(?to ?from)
  :effect(and
      not(at(?from)
    at(?to))
)
(:action move-right
  :parameters(?from ?to - location)
  :precondition(and
      at(?from)
      left-of(?from ?to))
  :effect(and
      not(at(?from)
      at(?to))
)
... analogously move-left and move-down
```

The actions above have identical effects and could be merged into a single move action:

```
(:action move
  :parameters(?from ?to - location)
  :precondition(and
    at(?from)
  :effect(and
    not(at(?from)
    at(?to))
)
```

For the new move action, any precondition that would restrict the ?from and ?to parameters cannot be learned to prevent conflicting preconditions. Although the logs may include the predicates (above ?11 ?12-location) and (left-of?11 ?12-location), the predicates can only be used if four separate move actions are synthesized for each direction instead of a single universal move action.

To prevent groupings of observations with different log labels, a change can be added to the L0 synthesis. The log labels are a form of additional information provided in the logs that assign a label to each transition. If the log data allows for a 1-1 mapping between log labels and action, 11 synthesis can be used and the log labels can be treated as action labels.

### Workbench

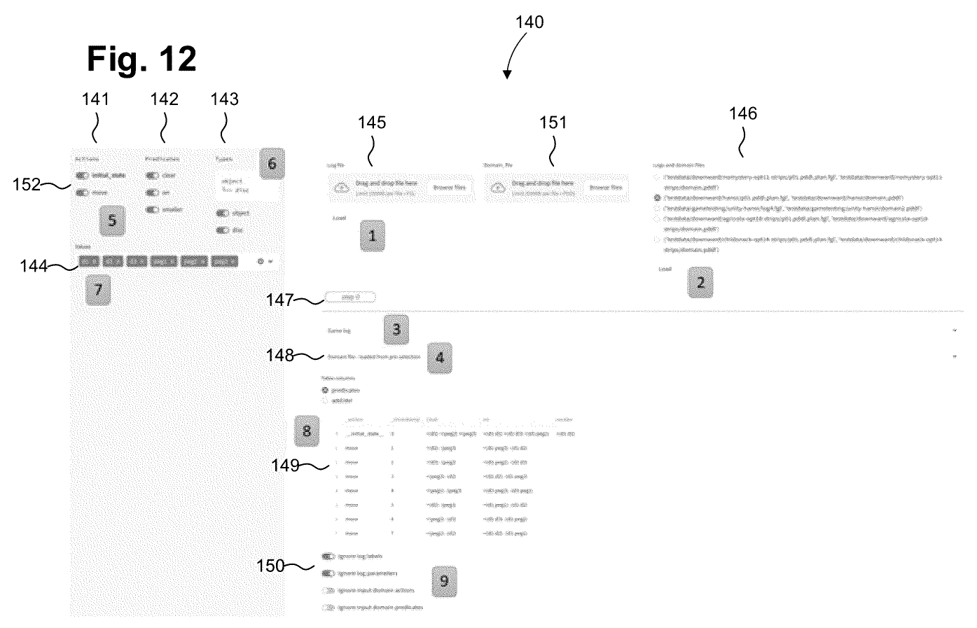

The user interface for automated domain synthesis can include a synthesis workbench, which includes input selection, controls and synthesis outputs, and can drive the domain synthesis user through the steps allowing user interaction. FIG. 12 is screenshot of the user interface of the system for automated data-driven domain synthesis of FIG. 2. The user can select a log 145 to synthesize the domain along with a domain draft 151, which can be partially complete or empty. A pre-selection of logs or domain 146 for open work can be loaded in a faster manner than selecting logs and domain from local directories.

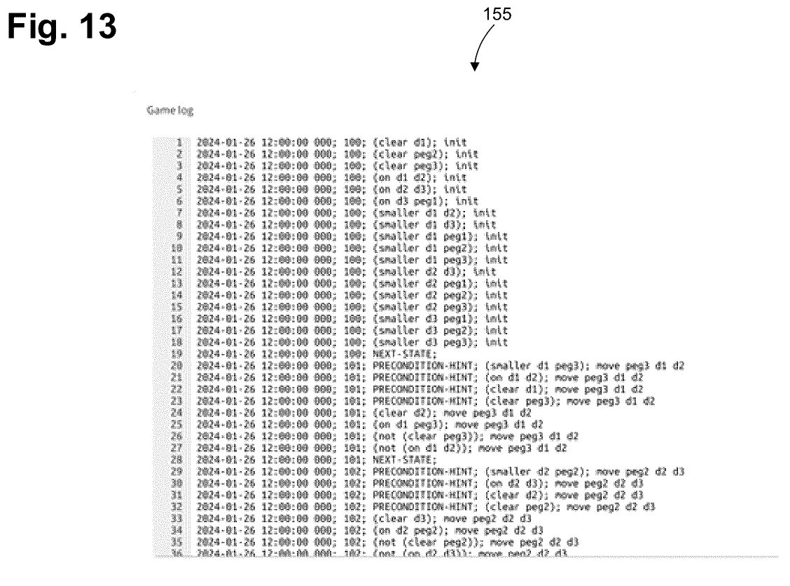

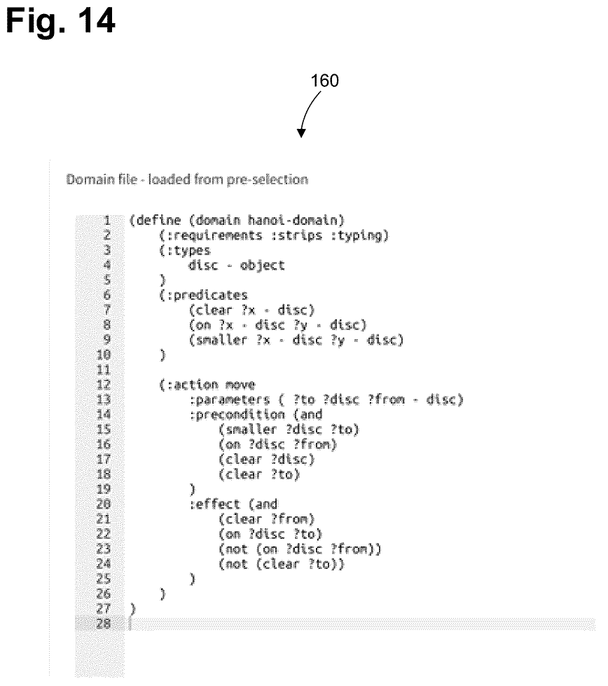

The loaded log can be displayed for examination and validation that all necessary data is included and that the log conforms to an L2, L1, or L0 type of log. FIG. 13 is a screenshot showing, by way of example, a log 155 loaded via a user interface. The log 155 includes multiple entries, each identified by a date and timestamp. Further, the loaded domain draft can also be displayed via the user interface. FIG. 14 is a screenshot showing, by way of example, a domain draft 160 loaded via the user interface. Once loaded, the domain draft 160 can be examined and edited according to the user.

Returning to the discussion with respect to FIG. 12, the user interface includes controls 152 to enable and disable actions 141, predicates 142 or complete types 143, which are inferred from the logs. The controls 152 can include toggle buttons, dropdown menus, or other types of controls. By disabling a control button for an option under one of the categories of actions, predicates or types, the option is filtered from the logs, which simplifies the domain and enables the iterative approach to synthesis. The slot types 143 of particular predicates are shown with hierarchy, which defines more or less general types. Disabling a particular type automatically disables more specific types.

A set of all objects 144, present in the log, is listed for display via the user interface. One or more objects can be optionally disabled to remove that object from the logs, which may not be important for synthesis. The logs are visualized in the form of a changelog, in a table. The changelog can include predicates, which are shown as table columns. Each row can state each log object with a+ or − sign to denote that the object in this predicate makes the predicate true or false for a given action.

Alternatively, the changelog can include a simpler view where each row represents one action and the columns of the table state predicates and object values which are true (positive) as a result of the action or false (negative). The changelog representations can be selected by the user and allows the user to identify and view parts of the logs on which the user is focused. In addition to changing a view of the changelog, the automated domain synthesis can have multiple options 150 that simplify the approach to logs, including the option of log conversions from L0 to L1 and L1 to L2 formats and an amount of help with pre-loaded domain, including whether to take actions and predicates into account.

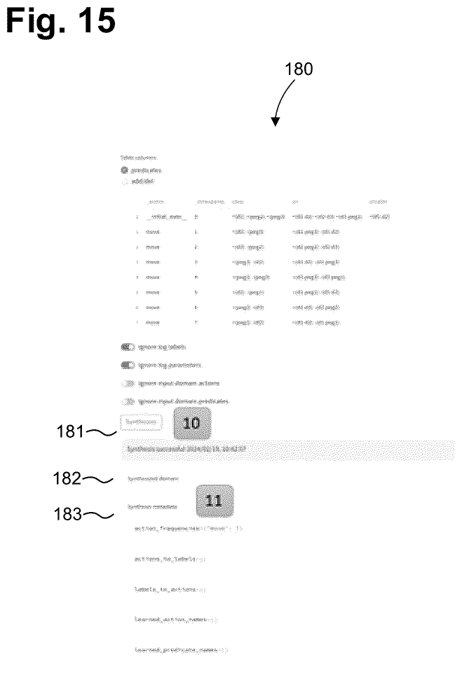

The user interface can also include controls for synthesis. FIG. 15 is a screenshot showing, by way of example, options for controlling and displaying synthesis metadata via the user interface. Once the user has selected options and representations for the predicate and action data, synthesis can begin via a button 181. As a result, a synthesized domain 182 and synthesis metadata 183 are provided.

The synthesis metadata 183 provides detailed information about a frequency of synthesized actions, which can reveal under-used actions, derived from pre-loaded domain, or over-used actions which may reveal a too general synthesized action. The mapping from L1 action names to newly synthesized actions is possible as well. Learned action names apply to the case when the pre-loaded domain is empty and the synthesis algorithm extracts these from logs with the help of LLM, which provides better user-readable action names.

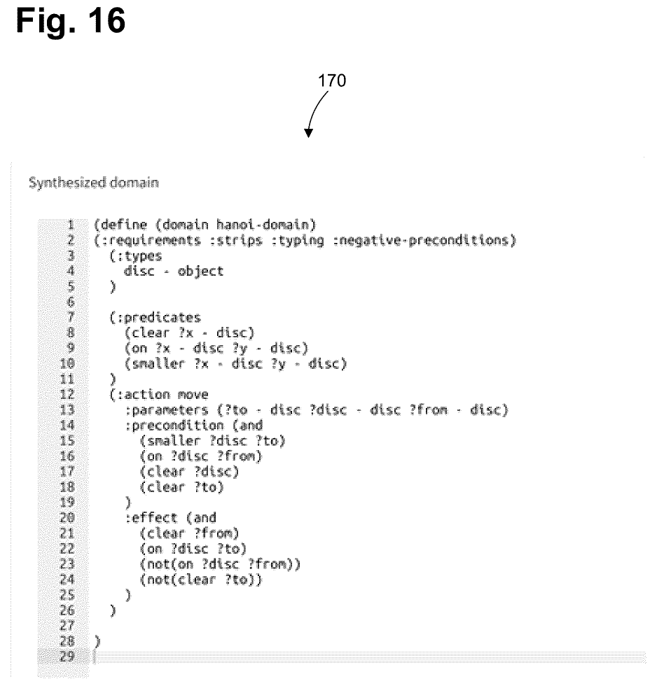

A synthesized domain is shown to the user for validation and examination. As a domain-expert, the user can spot too general or too specific parts of actions that can be adjusted in a next step of the iterative approach to domain synthesis. FIG. 16 is a screenshot showing, by way of example, a synthesized domain 170. The synthesized domain 170 includes predicates, actions, and effect.

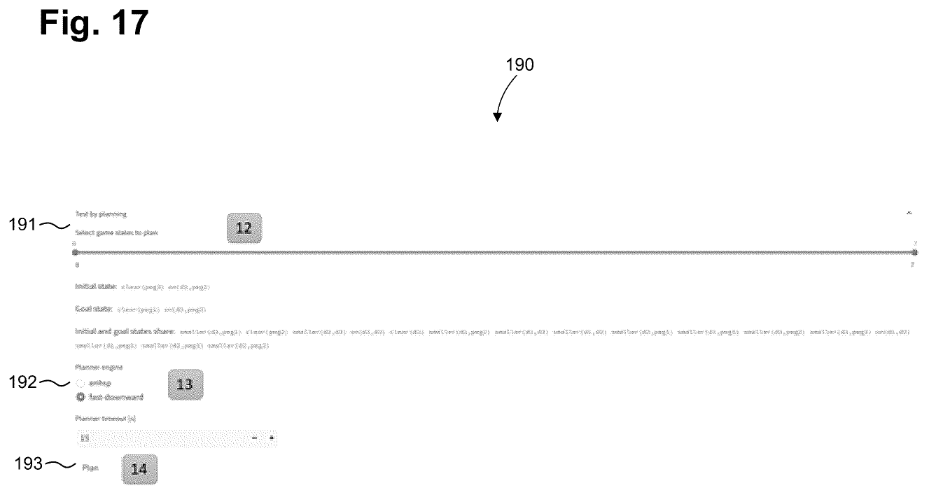

The user interface can also provide more options for auto synthesis. FIG. 17 is a screenshot showing, by way of example, additional synthesis options provided by the user interface 190. The synthesis workbench of the user interface offers a way for debugging synthesized domain. Specifically, a planner 191 is connected to the workbench and allows for running the synthesized domain and solving a planning problem that is created from the logs by selecting starting and goal states. The user can select a particular planner 192, each having their specialties with respect to domain processed, performance options and as such, by running the synthesized domain and original log file-based problem, it can quickly partially validate possible missing or superfluous actions and preconditions. If found, the plan is displayed to the user. Otherwise, the synthesis workbench reports “plan does not exist” or “plan not found within the given time limit.” This can be used for a first quick check for the user that the domain model is viable with respect to all settings in previous numbered points. The initial and goal state is given by the slider which selects first line of changelog as the input state and last line of changelog as a goal state. This allows for delicate selection of transfers between logs and their interactive, incremental testing before moving to the next step.

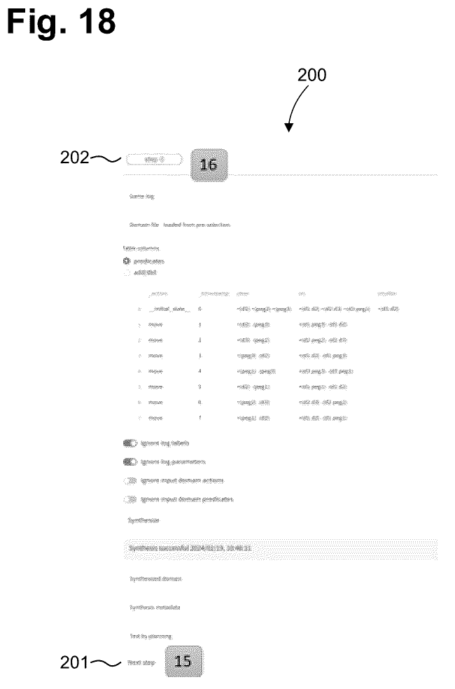

Subsequently, a button can be selected to open a new tab in a steps selection area 202. FIG. 18 is a screenshot showing, by way of example, options for the synthesized domain displayed via the user interface 200. The next button 201 is displayed and guides the user to a step in which the log record remains the same, but the domain used is the result of synthesis. All the controls are refined with respect to the synthesized domain and the user can edit the synthesized domain, enable/disable action preconditions to make them more or less specific, to change the synthesis options, and to run the next round of synthesis and further examine its output.

Once the button 201 is selected, the new tab appears where the domain can be changed, predicates added or deleted, testing performed until the user is satisfied with the final model or next step is pressed again to experiment more with the domain.

When modeling a domain, mistakes can be made. The mistakes can include when the model underapproximates the modeled problem and allows for logs that should not be possible or when the model overapproximates the problem and there is no plan or some logs that should be possible, cannot be generated. Thus, debugging helps resolve such mistakes. Generally, debugging the model that underapproximates is easier since the user identify the mistake from invalid logs obtained from the planner. Debugging a model that overapproximates the problem is harder since the user is not receiving any useful information due to the non-existence of logs.

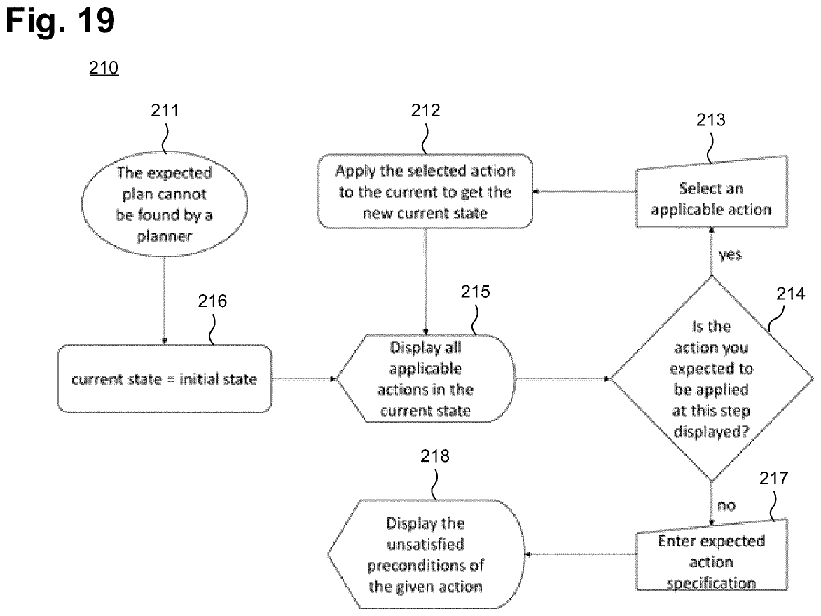

FIG. 19 is a flow diagram showing, by way of example, a process 210 for debugging models that overapproximate a problem. When an expected plan cannot be found by a planner, debugging can occur, during which an initial state, such as defined in the problem.pddl, is identified and set as the current state 216. The system displays all grounded actions that are applicable at the current state 215. The user inspects the displayed actions and if an action is identified that should be applied next 214, that action can be selected 213. Otherwise, if not applicable, the user can enter the action expected to be applicable 217 and the debugging tool can determine why that action is not applicable, such as the preconditions do not hold. The unsatisfied preconditions of the given action can be displayed 218. The selected action is applied to the current state 212 and a new state is created, which is designated as the current state.

With the debugging process, the user can find out why a plan they believe should be possible under a given model is actually not possible. The user can continue selecting a next action they believe should follow until the action they wish to choose does not appear between the applicable actions. At this point, looking at the already executed actions and changes on the states, should give some hints regarding the modelling mistake. Furthermore, a determination as to whether the action expected to be applied is displayed, can be automated by having an algorithm heuristically choose an action or set of actions. In the setoff action view, the evaluator could quickly look at traces n-steps from the initial state and identify missing or biased vectors. Alternatively, an entire plan, such as a sequence of actions, that are expected to be valid can be provided. The tool can determine which is the first non-applicable action and why, such as those preconditions that do not hold.

### Evaluating Models

Given a PDDL domain model, test cases can be automatically generated to evaluate the performance of various automated planners on solving various problems of that domain. For such purposes, it is important to generate problem instances that are solvable and to generate sets of instances of various difficulty levels to test the scalability of the planning system. Both points can be addressed using a semi-automatic method of problem generation.

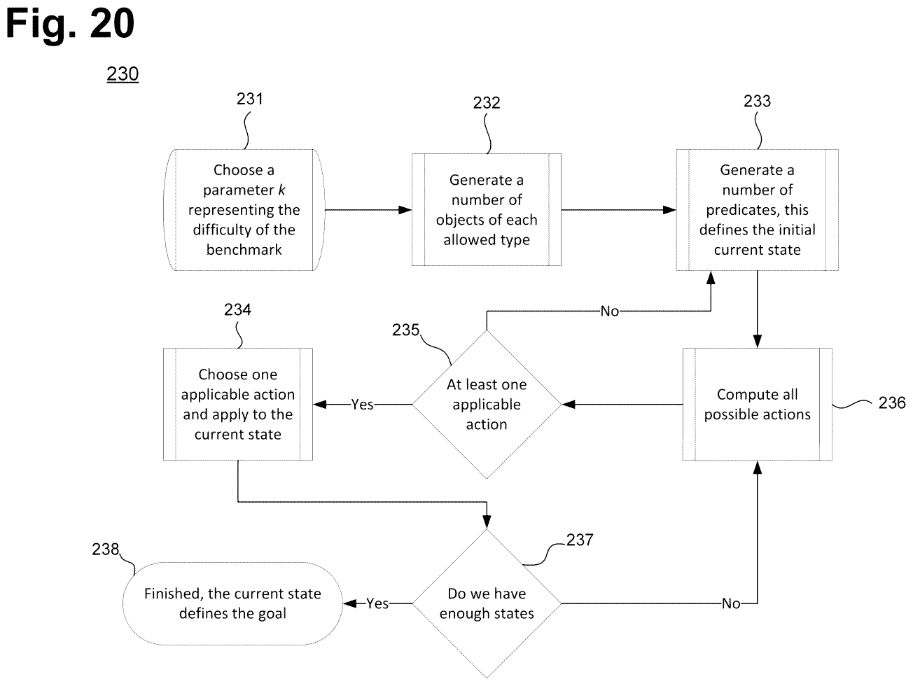

FIG. 20 is a flow diagram showing, by way of example, a process 230 for evaluating models. A semi-automatic method of problem generation can be used for evaluation. For example, in step 1, let k be a parameter defining the difficulty level of the desired problem (step 231). A fixed amount (depending on the properties of the problem domain and k) of objects of each type can be generated (step 232), and some fixed amount (depending on the properties of the problem domain and k) of predicates using the objects generated in step 2 can also be generated (step 233). The generated set of predicates define the initial state of the generated test-case. The initial state is set to be the current state in the algorithm. All applicable actions in the current state are calculated (step 236) and selected in a uniformly random fashion, such as by using a pseudo-random generator algorithm. If the set of applicable actions is empty, a different number of predicates can be generated. The selected action is applied to the current state and the resulting state is set to be the new current state (step 235). Calculating applicable actions (step 236) and applying the selected actions to a current state (step 235) are repeated for a fixed number of times (depending on the properties of the problem domain and k, which can be multiplied by a constant). If there is at least one state (step 235), then the application action can be selected and applied to the current state (step 234). A determination is made as to whether enough states have been identified based on the parameter k, for example have at least 10 times k states been identified (step 237). If so, the process is finished and the state arrived at defines the goal state of the generated test-case (step 238).

Each problem generated using this method is guaranteed to be solvable, indeed one solution is the sequence of actions selected in the iterations of step 3. By increasing/decreasing the parameter k that can increase/decrease the difficulty of the generated problems.

The models can be used in a composite AI system that integrates multiple models and techniques, such as AI planning, machine learning, scheduling, graph theory, constraint programming and large language models, can be used for solving problems across different domains, such as industrial automation and intelligent service creation, as further described in detail in U.S. patent application Ser. No. ______, titled “System and Method for Specification, Codification, and Deployment of Composite Artificial Intelligence Systems, filed on Jul. 1, 2024, which is hereby incorporated by reference in its entirety

While the invention has been particularly shown and described as referenced to the embodiments thereof, those skilled in the art will understand that the foregoing and other changes in form and detail may be made therein without departing from the spirit and scope.

What is claimed is:

1. A method for automated data-driven domain model synthesis, comprising:
receiving logs of data from a target system for which at least one goal is to be achieved;
determining from the received logs, a set of predicates that describe a domain of the target system and represent an initial state and sequence state changes, wherein each predicate applies to one or more objects in the domain;
identifying the actions that are high level plan steps regarding achieving the goal;
transforming the identified actions that are high level plan steps to actions that are low level execution steps to be performed for achieving the goal;
transforming the actions that are low-level execution steps to be performed for achieving the goal to actions that are high-level plan steps regarding achieving the goal;
performing domain synthesis to create a model that describes data from the logs by adding the predicates and actions needed to cover all the logs and achieve the at least one goal;
determining whether the model covers all the logs; and
revising the model by adding one or more missing predicates or actions when the model fails to cover all the logs.

2. A method according to claim 1, wherein each predicate resolves as true or false.

3. A method according to claim 1, wherein the logs of data are received via a data connector that converts the data to an action description with parameters that describe actions to be executed in the target system to solve the problem to be solved.

4. A method according to claim 1, further comprising:
classifying each log as a type of log; and
synthesizing the actions based on the type.

5. A method according to claim 1, further comprising:
attempting to perform an interpretation of the logs with the model.

6. A method according to claim 5, further comprising:
revising the model by adding new types, predicates, and actions when the interpretation of the logs with the model is unsuccessful.

7. A method according to claim 1, further comprising:
receiving user feedback regarding one or more of the predicates, actions, and model via a user interface.

8. A method according to claim 1, wherein the model is based on an input model received that is blank.

9. A method according to claim 1, further comprising:
identifying two or more of the actions to be merged;
merging the actions; and
in the model, replacing the two identified actions with the merged action.

10. A method according to claim 1, further comprising:
performing debugging of the model; and
determining whether a mistake exists in the model based on the debugging.

11. A method according to claim 1, further comprising:
prior to identifying the actions that are high level plan steps, transforming the actions that are low-level execution steps to be performed for achieving the goal to actions that are high-level plan steps regarding achieving the goal.

12. A method according to claim 1, comprising:
generating at least one benchmark problem for a planning domain in a domain-specific language;
establishing a difficulty parameter for complexity of the benchmark problem;
creating objects and predicates as an initial state of the benchmark problem based on domain properties and the difficulty parameter;
selecting actions randomly to transition through states to define a valid action sequence; and
through repeated action applications, determining a goal state of the benchmark problem based on a final state achieved after applying the repeated action applications to the initial state.

13. A system for automated data-driven domain model synthesis, comprising:
a database to store logs of data from a target system for which at least one goal is to be achieved;
a server comprising a central processing unit, memory, an input port to receive the logs of data, and an output port, wherein the central processing unit is configured to perform steps to:
determine from the received logs, a set of predicates that describe a domain of the target system and represent an initial state and sequence state changes, wherein each predicate applies to one or more objects in the domain;
identify the actions that are high level plan steps regarding achieving the goal;
transform the identified actions that are high level plan steps to actions that are low level execution steps to be performed for achieving the goal;
perform domain synthesis to create a model that describes data from the logs by adding the predicates and actions needed to cover all the logs and achieve the at least one goal;
determine whether the model covers all the logs; and
revise the model by adding one or more missing predicates or actions when the model fails to cover all the logs.

14. A system according to claim 13, wherein the logs of data are received via a data connector that converts the data to an action description with parameters that describe actions to be executed in the target system to solve the problem to be solved.

15. A system according to claim 13, wherein the central processing unit performs the following:
classify each log as a type of log; and
synthesize the actions based on the type.

16. A system according to claim 13, wherein the central processing unit attempts to perform an interpretation of the logs with the model.

17. A system according to claim 15, wherein the central processing unit revises the model by adding new types, predicates, and actions when the interpretation of the logs with the model is unsuccessful.

18. A system according to claim 13, wherein the central processing unit receives user feedback regarding one or more of the predicates, actions, and model via a user interface.

19. A system according to claim 13, wherein the model is based on an input model received that is blank.

20. A system according to claim 13, wherein the central processing unit performs the following:
identify two or more of the actions to be merged;
merge the actions; and
in the model, replace the two identified actions with the merged action.

21. A system according to claim 13, wherein the central processing unit performs debugging of the model and determines whether a mistake exists in the model based on the debugging.
